(19) United States
(12) Patent Application Publication
(10) Pub. No.: US 2023/0329965 A1
(43) Pub. Date: Oct. 19, 2023

(54) Selectable, Configurable and Interchangeable Massage Tool Head System For Percussion Massage Devices

(71) Applicant: PlayMakar Inc., Fort Worth, TX (US)

(72) Inventors: Michael James Williams, Colleyville, TX (US); Federico G. Vierheller, Fort Worth, TX (US); Wesley A. Coleman, N. Richland Hills, TX (US)

(73) Assignee: PlayMakar Inc., Fort Worth, TX (US)

(21) Appl. No.: 18/309,918

(22) Filed: May 1, 2023

Related U.S. Application Data
(63) Continuation-in-part of application No. 17/714,140, filed on Apr. 5, 2022, now Pat. No. 11,672,728.

(51) Int. Cl. A61H 23/00

(52) U.S. Cl. CPC A61H 23/006; A61H 2201/1685; A61H 2201/169; A61H 2201/1664

(57) ABSTRACT

A selectable impact tip system for percussion massagers that allows users to select and interchange tips based on user preference and targeted customization for comfort, muscle density, muscle soreness, body part and clinical application.

### CROSS-REFERENCE TO RELATED APPLICATIONS

The present application is a continuation-in-part of U.S. application Ser. No. 17/714,140 entitled SELECTABLE, CONFIGURABLE AND INTERCHANGEABLE MASSAGE TOOL HEAD SYSTEM FOR PERCUSSION MASSAGE DEVICES which was filed on Apr. 5, 2022, the entirety of which is incorporated herein by reference.

The present application cross-references and incorporates herein by reference: U.S. patent application Ser. No. 17/223,840 entitled PERCUSSIVE MASSAGER ROTATIONAL ACCESSORY, filed Apr. 6, 2021; U.S. patent application Ser. No. 17/229,860 entitled VARIABLE STROKE PERCUSSIVE MASSAGE DEVICE, filed Apr. 13, 2021, now U.S. Pat. No. 11,253,423; U.S. patent application Ser. No. 17/508,954 entitled CONSTRAINED AND REPOSITIONABLE PERCUSSIVE MASSAGE DEVICE TOOL AND TOOL RECEIVER, filed Oct. 22, 2021; U.S. patent application Ser. No. 17/524,732 entitled PERCUSSION MASSAGER HAVING VARIABLE AND SELECTABLE STROKE LENGTH filed Nov. 11, 2021; U.S. patent application Ser. No. 17/740,143 entitled SYSTEM AND METHOD FOR LOCKING PERCUSSION SETTINGS ON A MASSAGE DEVICE filed May 9, 2022; and patent application Ser. No. 18/183,463 entitled ROTATIONAL ACCESSORY FOR A PERCUSSION MASSAGER filed Mar. 14, 2023, each of which is commonly owned and list overlapping inventors.

### BACKGROUND

### Technical Field

The embodiments herein are generally directed to tips used with percussion massage tools and more specifically to tips and tool designs which enable customization of a massage experience by controlling impact force.

### Description of Related Art

Massage devices are known in the art and present uses include, but are not limited to, pre-work out warm-up or post-activity recovery to increase range of motion and flexibility when administered before sports activity and muscle pliability where massage techniques are applied with a thumb, palm and elbow, used to reduce stress, increase relaxation, reduce pain and muscle soreness and tension. Improving circulation, energy and alertness. Massage devices have also been known to help prevent sore muscles after exercise known as “delayed onset muscle soreness or DOMS. Such massage devices are used in, for example, athletic, physiotherapeutic and chiropractic environments and to a much larger extent now in the home environment. Current tool heads, including massage tips, for percussion massage devices are somewhat inflexible in their design and rely on the body tissue to act as the primary shock absorber. Current tool head tips are composed of hard plastic or closed cell foam and do not offer users various measured tool heads based on impact and do not take into account the users body, needs and use application.

Further, prior art designs may be causing damage to the fascia, i.e., a thin casing of connective tissue that surrounds and holds every organ, blood vessel, bone, nerve fiber and muscle in place. When hammering into this area with a high intensity motor, blood vessels can rupture, creating inflammation, and ultimately cause bruising. This counter to the goal of massage therapy, which is to increase blood flow that transports beneficial oxygen and nutrients to our muscles. When we shatter these pathways, we counteract the potential gains.

Accordingly, there is a need in the art for tip and/or tool designs that allow a user to customize the impact based on comfort, body part impacted, medical needs.

### SUMMARY OF THE EMBODIMENTS

A selectable impact tip system for percussion massagers that allows users to select and interchange tips based on user preference and targeted customization for comfort, muscle density, muscle soreness, body part and clinical application.

To impose greater mechanical control on applied force and impact control on percussion massage tool head impact the embodiments exemplified herein use various mechanical absorption and reverberation methods including fixed and non-fixed methods such as springs, pneumatics, tip design and elastomeric durometer scales. Greater control of reverberation, spring back and absorption is achieved through one or more of the following:
Tool heads may use various compression force values.
Tips may use a pneumatic bladder that may be inflated or deflated. Pneumatic tips may have valve on outside and/or from within the shaft to control inflation/deflation.
Tip material durometer and density may be changed to reduce/increase impact forces as desired.
Tip design that features air transfer capability and air visibility chamber. Tip is a mechanical damper device designed to absorb and damp shock impulses created for the percussion massager device. It does this by converting the kinetic energy of the shock into another form of energy which is then dissipated by the geometrical shape of the attachment by having an air chamber that allows the tip of the attachment to flex in a controlled distance, represented by the “air chamber.”
Tip shafts may use fixed shafts, with adjustability to reduce the gap between tip head and “bottom out” point. This distance becomes variable when adjusted with a device (screw) that attaches firmly to the shaft of the attachment and having the property of modifying the space of the “air chamber”, changing as a result the shock dampening properties of the flexible tip.
Tips may be visibly coded to give users can easily identifiable way and progressive system to quickly locate appropriate tip for use in applications.

Example embodiments in general relate to an attachment system for a percussive massager device, wherein users may select the attachment heads in a percussive massager device based on the desired impact energy of the collision force. A color coding, alphanumeric coding, graphics coding or other visual indication system may be implemented to provide a user with an indication of the level of impact that is to be expected for each massage tip in a set.

One object of the embodiments is to provide tool head attachments primarily designed to be used in massage instruments which include shock attenuation and impact absorbing functions.

One object is to provide an attachment system for a percussive massager device to facilitate user selection of a specific attachment based on the impact energy of the collision force as indicated through a coding system.

Other objects and advantages of the various embodiments of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

In a first embodiment herein, a massage head tip for use with a massage tool for a percussive massaging device includes: at least two sections, wherein a first of the at least two sections is formed of a first material having a first durometer value and a second of the at least two sections is formed of a second material having a second durometer value; and further wherein the first durometer value is equal to or greater than the second durometer value.

In a second embodiment herein, a percussive massaging device includes: a removable hollow shaft connected on a first end to a tool receiver, including a piston, and at a second end to a massage tool; wherein the massage tool includes at least one tool head tip, the tool head tip having at least two sections, wherein a first of the at least two sections is formed of a first material having a first durometer value and a second of the at least two sections is formed of a second material having a second durometer value; and further wherein the first durometer value is equal to or greater than the second durometer value.

In a third embodiment herein, a massage tool for a percussive massaging device includes: a tool head having an attachment post at a first end thereof for attaching to a tool receiver and dual fork ends at a second end thereof, wherein each of the dual fork ends includes a tool head tip attached thereto; each tool head tip having at least two sections, wherein a first of the at least two sections is formed of a first material having a first durometer value and a second of the at least two sections is formed of a second material having a second durometer value; and further wherein the first durometer value is equal to or greater than the second durometer value.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIGS. 1a and 1b illustrate a first low impact tool configuration in accordance with a first embodiment described herein;

FIGS. 1c, 1d and 1e illustrate impact stages of the tip and tissue for the tool configuration of FIGS. 1a and 1b in accordance with a first embodiment described herein;

FIGS. 2a and 2b illustrate a second low impact tool configuration in accordance with a first embodiment described herein;

FIGS. 3a, 3b and 3c illustrate a third low impact tool configuration in accordance with a first embodiment described herein;

FIGS. 3d and 3e illustrate the third low impact tool configuration in a first open spring state (FIG. 3b) and a second closed spring state (FIG. 3c);

FIGS. 4a, 4b and 4c illustrate a third low impact tool configuration having a roller tip in accordance with a first embodiment described herein;

FIGS. 4d and 4e illustrate the third low impact tool configuration having a roller tip in a first open spring state (FIG. 4b) and a second closed spring state (FIG. 4c);

FIGS. 5a, 5b, 5c, 5d illustrate an exemplary tool set for use with a percussion massage device, wherein each individual tool is marked to identify impact range to the user;

FIGS. 6a and 6b illustrate a first low impact tool configuration in accordance with a first embodiment described herein having an alternative tool tip;

FIGS. 7a and 7b illustrate a third embodiment tool head wherein a first low impact tool configuration in accordance with a first embodiment described herein has an alternative tool tip;

FIGS. 8a and 8b illustrate a fourth embodiment tool head wherein a first low impact tool configuration in accordance with a first embodiment described herein has an alternative tool head;

FIGS. 8c, 8d and 8e illustrate a fifth embodiment tool head wherein a second low impact tool configuration in accordance with a first embodiment described herein has the alternative tool head of FIGS. 8a and 8b;

FIGS. 9a, 9b and 9c illustrate a fifth embodiment tool head wherein a tool head is inflatable;

FIGS. 10a, 10b, 10c and 10d illustrate the tool head of the fifth embodiment at various PSI of inflation;

FIG. 11 is an exemplary graph illustrating impact force (Joules) required to achieve tool tip compression (mm) for different tip designs during use with a percussion massage device. wherein the tip durometer is the same across;

FIGS. 12a, 12b, 12c and 12d illustrate different tool configurations with a cone tip;

FIGS. 13a, 13b, 13c and 13d illustrate different tool configurations with a paddle tip

FIGS. 14a, 14b and 14c illustrate a single tool tip configuration having different hardness levels at exemplary impact stages;

FIGS. 15a and 15b illustrate an exemplary tool tip and cross-sectional view showing snap-fit of removable tool tip to shaft;

FIG. 16 graphs Force v. Time for an exemplary tool tip having a same configuration with different hardness levels; and

FIGS. 17a, 17b, 17c and 17d illustrate an exemplary percussion massage device having a rotatable tool, which includes one or more of the tool tips described herein.

### DETAILED DESCRIPTION

A dynamic response analysis in an elastic collision teaches us that objects involved remain separate, where the total kinetic energy and momentum are conserved. This means that the colliding objects bounce off one another with no energy loss as a result of the collision. In the case of percussion massage tips, the interaction with the body is a “nearly elastic collision” because some kinetic energy is lost in heat, sound, and internal energy allowing the body tissue to wave as a result. In the present embodiments, total momentum is conserved and the total kinetic energy is not conserved. The collision is considered to be elastic because the tip, which is deformed during collision, and the body tissue, also deformed during collision, both return to their original state after the collision. Also relevant is the concept of shock loading which refers to a sudden and drastic increase of load similar to a hammering effect. The net force is equal to the derivative of momentum as a function of time defining impact as a change in momentum, represented by the change in the response velocity of the tool head tip of the absorbing device and human tissue.

The typical percussion massager attachment tip uses one or more materials or components which affect the force of impact in two important ways, i.e. through shock absorption and energy absorption. Shock absorption involves the attenuation of harmful impact forces. A percussion massager attachment tip with high shock absorbing and reverberation characteristics thus can provide a more beneficial massager therapy experience, assuming other mechanical aspects are not compromised. Absorption of energy may be considered the general soaking up of both impact and useful propulsive forces. Thus, a percussion massager attachment tip with high energy absorbing and reverberation characteristics has relatively lower resiliency, which generally does not return as much of the energy placed into the tip at soft tissue impact. Furthermore, high absorbing and reverberation tips can also produce a continuation or extended massage stroke length creating a secondary impact. This results in a continuing effect or repercussion. Conversely, a percussion massage tip with low energy absorbing characteristics has relatively higher resiliency, and generally returns more of the energy placed into a tip at soft tissue impact.

Rubber or elastomeric materials are widely used for shock absorbers having elastic and viscous properties such as high inherent damping, deflection capacity, and energy storage. By definition damping properties of rubber is fulfilled for a system with kinematic excitation based on two approaches: using Maxwell and Burgers mechanical models combining of elastic and viscous elements and using Rabotnov's kernel of relaxation for analytical representation of visco-elastic properties of rubber.

The following embodiments illustrate just a few of the different ways that a user can customize their percussion massage experience by either selecting a specific predetermined tip design with set force expectation and/or adjusting force using one or more customization controls available with the tool tip.

### A. Low Level Impact

In a first embodiment, an exemplary tool head for use with a percussion massager is intended to provide a user with the lowest impact level experience, or levels, as compared to other tool head configurations in a set of tool heads. Impact level can vary based on a number of factors including tool configuration, tip shape (external and internal) and material, as well as user selectable changes to the tool configuration as will be discussed herein. Use of the terms low, medium and high herein are relative.

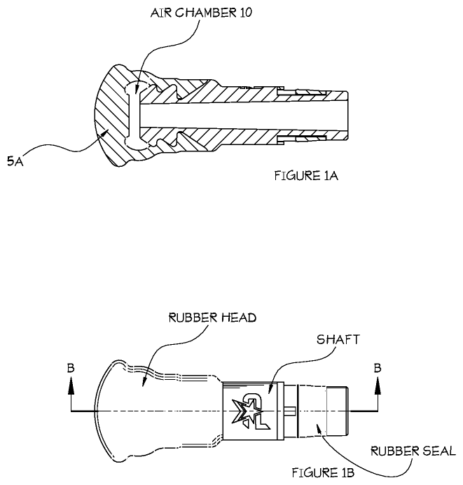

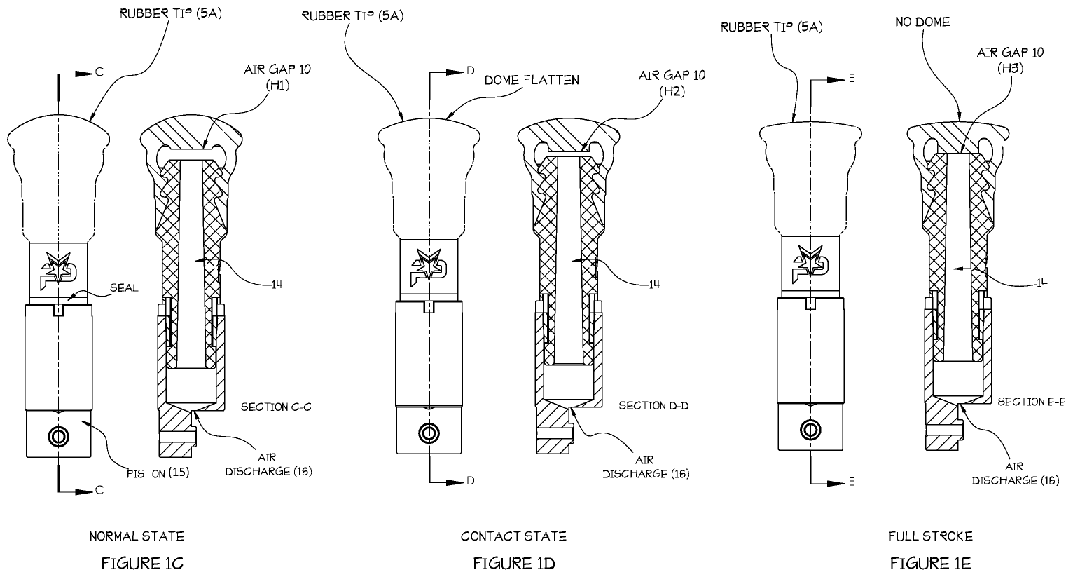

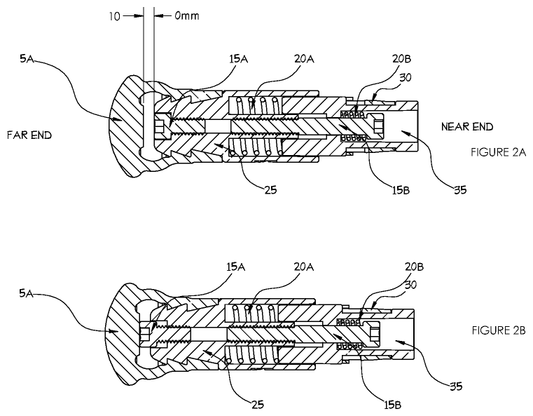

A first low impact tool configuration is represented by a tool configuration which includes a tip shape as shown in FIGS. 1a and 1b and which includes an air chamber or gap 10 as shown in FIG. 1a. The tip 5A material is formed of a rubber material having a predetermined durometer value, such as 60, on the Shore A durometer scale. The air chamber may be, for example, on the order of 0-10 mm. In one particular embodiment, wherein the tip includes a transparent portion, wherein the air chamber is visible during use of the percussion massage attachment tool. In an exemplary configuration, a 5 mm tip deformation results from an impact force of approximately 6.52 Joules.

FIGS. 1c, 1d, 1e show a second exemplary massage tip with air transfer from the air gap as the tip compresses during a stroke of the percussion massager as the tip encounters tissue of the user. As shown in FIG. 1c, the stroke has not closed the air gap 10 and thus there is no compression yet. Whereas in FIG. 1d the air gap narrows and in FIG. 1e there is essentially no gap. In FIG. 1c, a flexible rubber tip 5A in a normal (or resting) state includes an air gap of approximately 4 mm and a dome peak to flat (horizontal) plane measurement of 6.53 mm. Next, during a percussion stroke, as the dome peak of the rubber tip contacts the tissue of the user, the air gap narrows to 2 mm and the dome peak to flat (horizontal) plane measurement reduces to 2.42 mm (FIG. 1d). Finally, at the point of full stroke, the air gap goes to 0 and the dome peak to flat (horizontal) plane measurement reduces to 0.79 mm (FIG. 1e). Air from the air gap may be released during the stroke through one or more channels in the core 14 and out of the tool via one or more vents 16 in the piston 15.

Percussion massager attachment tip system of FIGS. 1c, 1d, 1e show more controlled impact and reverberation. The tips' shape and geometry of the inner cavity is engineered to absorb impact and transfer gas while the lower aspect is designed to partially encapsulate the shaft creating a seal. Furthermore the tip is designed to create reverberation that generates secondary impact as the tip collapses and expands. The gap inside the head tip and the shaft could vary, adding differences in space inside that change reverberation distance. The creation of the space inside the tip allows the tip to collapse and expand, conforming to the tissue of the user and generating a secondary impact. The shaft has one or more channels which allow the tip to discharge gas through the shaft to the piston. The piston has one or more vents to allow air to discharge. The piston encapsulates the shaft and attaches via the elastomeric joint.

One skilled in the art appreciates that in accordance with the teachings herein, the air gap size and shape, dome material (e.g., rubber or elastomeric) and shape, the shaft channels and number of piston vents can all be varied to vary the overall impact experience to the user. In this first low impact configuration, the features of the tool and tip are set and static, i.e., there is no ability for a user to change one or more features of the tool out of the box.

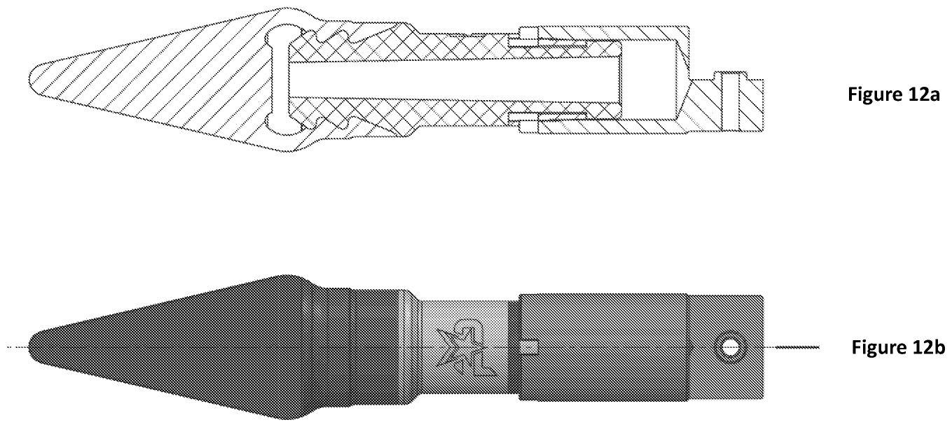

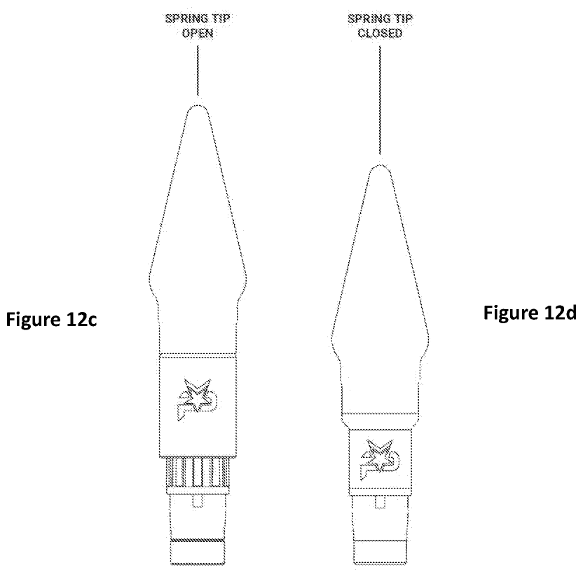

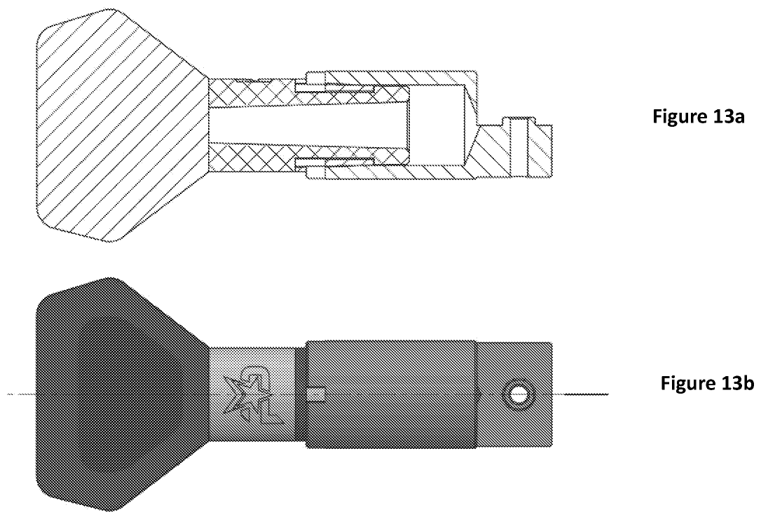

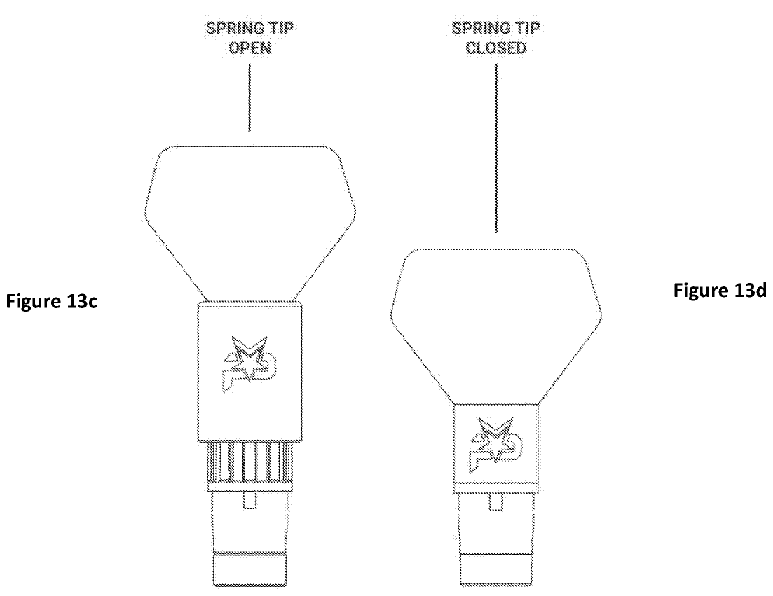

For a user seeking a higher impact level, a different tip could be selected to replace tip 5A on tool shaft 25. Other tips with differing shapes and/or durometer values can be selected to replace tip 5A and with the same internal geometry of the tool will result in a higher (or lower) impact level (see, for example, the tips described in commonly owned U.S. patent application Ser. No. 17/508,954 which is incorporated herein by reference in its entirety). The cone and paddle tips shown in FIGS. 12a, 12b (cone) and FIGS. 13a, 13b (paddle) with the tool configuration described above with respect to FIGS. 1c, 1d, 1e provide for additional examples.

In a second low impact tool configuration shown in FIGS. 2a and 2b, the user is able to increase the impact level by narrowing the air gap 10 using screw 15. In this configuration, all other features of the tool such as tip shape and durometer value are the same, but by decreasing the air gap 10, less impact is absorbed by the tool, resulting in more impact being felt by the user.

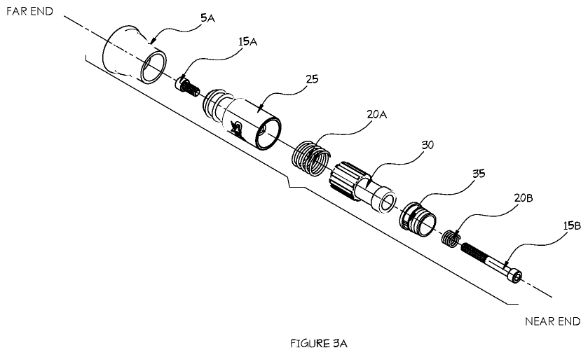

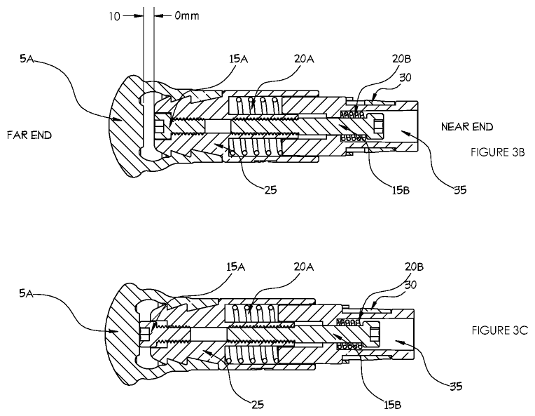

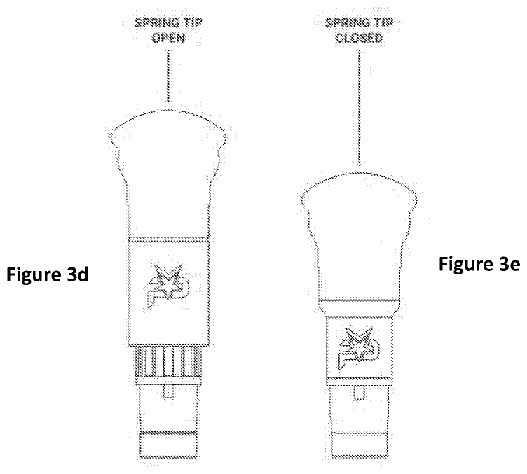

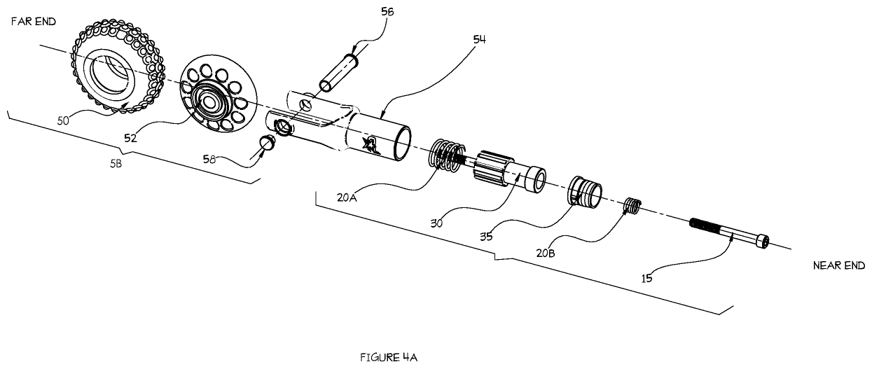

In yet a third low impact tool configuration, an additional impact selection mechanism is included which allows a user to adjust impact, in addition to changing the air gap 10 width. FIGS. 3a-3c illustrate a tool geometry which includes dual compression spring coils (springs) 20a and 20b, which can be adjusted between a fully open configuration (low impact, shown) and a compressed configuration (higher impact). Control screw 15a is used to adjust the air gap 10, while control screw 15b is used to compress/open the springs 20a and 20b. As you squeeze a compression spring, it pushes back to return to its original length. Rate is the amount of force required for every inch of compression or, for metric springs, millimeter of compression. The higher the rate, the harder it is to compress the spring. Springs 20a and 20b handle higher loads than standard fastener-mount compression springs. Springs 20a and 20b are secured by inserting an adjustable fastener 15B through the hole at the base. Recommended springs are a polyester/rubber blend that is wear, oil, and fuel resistant.

The internal geometry of the part directly controls the spring and the deformation of the rubber head to achieve specific results during a massage session. We obtain an s-curve when representing this deformation combined with forces through time.

FIGS. 3d and 3e illustrate the third low impact tool configuration in a first open spring state (FIG. 3d) and a second closed spring state (FIG. 3e). Impact force will be higher when the percussion massager is operating with the tool in the closed spring state.

One skilled in the art will appreciate that when the tip deformation distance changes, the force required changes too. The larger the deformation desired, the larger the required applied force. The nominal case described above was calculated based on 5 mm deformation. To establish a comparison, to deform the rubber tip 5A in the first low impact tool configuration to 7 mm, the force required is 20.84 Joules. This result is not a constant. The main deformation factors in the low level configurations discussed herein are the internal geometry, the mass, tip shape, tip material (durometer level) and the speed.

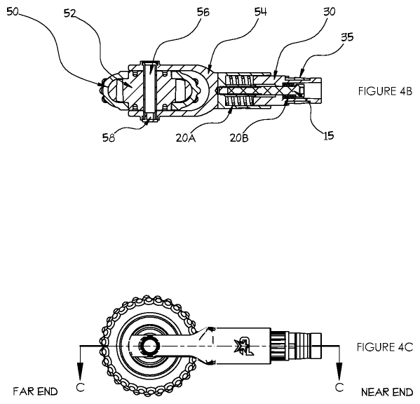

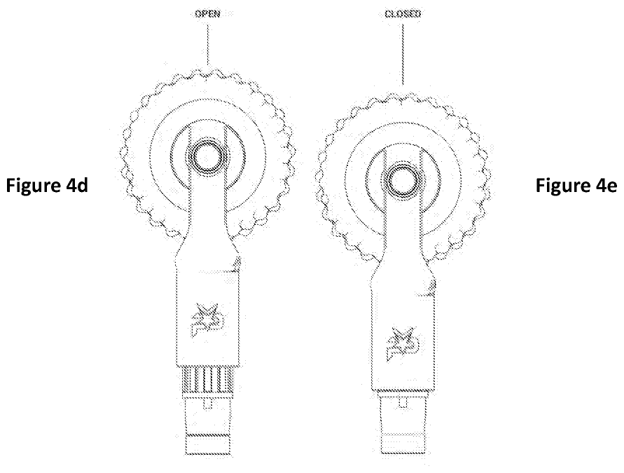

Additionally, one or more exemplary tips, including the roller tips described in commonly owned U.S. patent application Ser. No. 17/508,954 which is incorporated herein by reference in its entirety may be used in conjunction with a tool having the spring internal geometry described herein. Referring to FIGS. 4a, 4b and 4c, and exemplary roller tip 5B includes a wheel tire 50, wheel reem 52, strut 54, cup 56, axis elbow 58, spring seat 30, o-ring seal 35, along with dual compression spring coils (springs) 20a and 20b, which can be adjusted between a fully open configuration (low impact) and a compressed configuration (higher impact). Control screw 15 is used to compress/open the springs 20a and 20b. As you squeeze a compression spring, it pushes back to return to its original length. Rate is the amount of force required for every inch of compression or, for metric springs, millimeter of compression. The higher the rate, the harder it is to compress the spring. Springs 20a and 20b handle higher loads than standard fastener-mount compression springs. Springs 20a and 20b are secured by inserting an adjustable fastener 15B through the hole at the base. FIGS. 4d and 4e illustrate the third low impact tool configuration with roller tip 5B in a first open spring state (FIG. 4d) and a second closed spring state (FIG. 4e).

Additionally, the tool having the spring internal geometry described above may also be used with the cone and paddle tips shown in FIGS. 12c, 12d (cone) and FIGS. 13c, 13d (paddle).

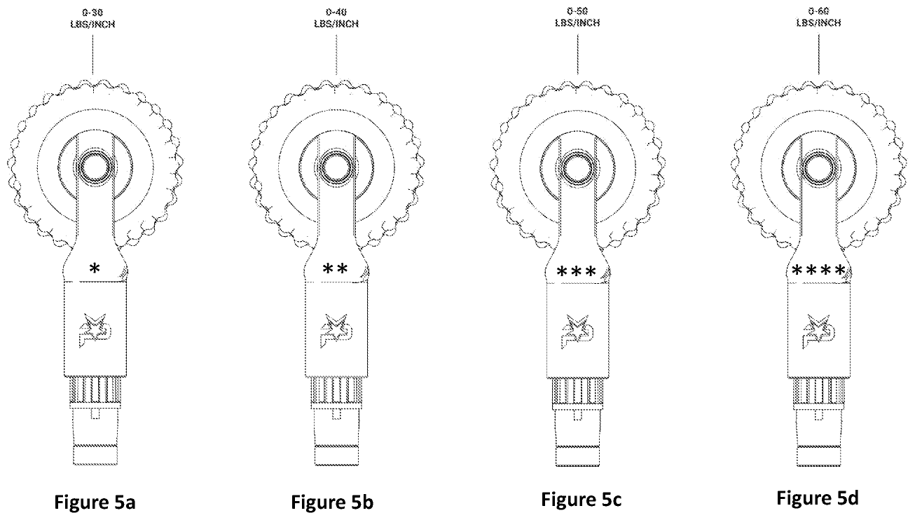

FIGS. 5a, 5b, 5c and 5d illustrate an exemplary tool set for use with a percussion massage device, wherein each individual tool is marked to identify impact range to the user. In the present example, stars represent impact level ranges available for each tool. In FIG. 5a, a single star (*) represents the tool providing the lowest level impact range for the set, e.g., 0-30 lbs/inch. In FIG. 5b, two stars (**) represent the tool providing the medium/low level impact range for the set, e.g., 0-40 lbs/inch. In FIG. 5c, three stars (***) represent the tool providing the medium/high level impact range for the set, e.g., 0-50 lbs/inch. And in FIG. 5d, a four stars (****) represent the tool providing the highest level impact range for the set, e.g., 0-60 lbs/inch. The changes in impact level range can be adjusted from tool to tool by, for example, using springs having different spring rates (K). One skilled in the art recognizes that the impact level indicators need not be limited to stars and could be colors, alphanumeric or other characters that would allow a user to easily distinguish the tools. Further, for embodiments herein where there is a single tool with multiple selectable tips having different impact level ranges, the tips will include the indicator for ease of selection.

### B. Medium/Low Level Impact

In a second embodiment, an exemplary tool head for use with a percussion massager is intended to provide a user with a medium/low impact level experience, or levels, as compared to other tool head configurations in a set of tool heads. Impact level can vary based on a number of factors including tool configuration, tip shape and material, as well as user selectable changes to the tool configuration as will be discussed herein. Use of the terms low, medium and high herein are relative.

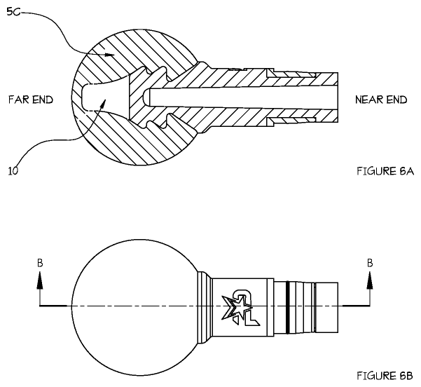

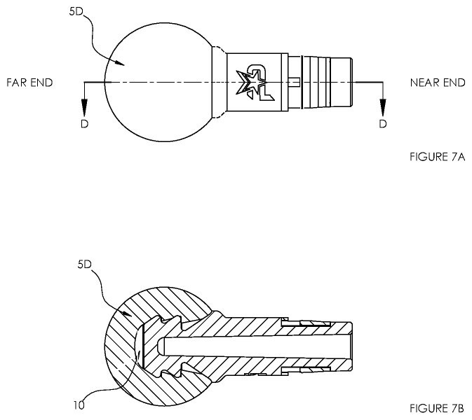

Referring to FIGS. 6a and 6b, the tip 5B of durometer value 60 as shown will deform 5 mm with an impact force of 16.74 Joules. By way of comparison, to deform tip 5B 7 mm, the force required is 73 Joules. Similar to the first low impact tool configuration of the first embodiment discussed above, this tool of FIGS. 6a and 6b is static, in that there are no adjustable features. But one skilled in the art will recognize that the variations introduced above with respect internal geometries of the second and third low impact tool configurations may also be applied hereto, by simply replacing tip 5A with tip 5B, thus providing a user with additional levels of impact to customize their massage experience.

### C. Medium High Level Impact

In a third embodiment, an exemplary tool head for use with a percussion massager is intended to provide a user with a medium/high impact level experience, or levels, as compared to other tool head configurations in a set of tool heads. Impact level can vary based on a number of factors including tool configuration, tip shape and material, as well as user selectable changes to the tool configuration as will be discussed herein. Use of the terms low, medium and high herein are relative.

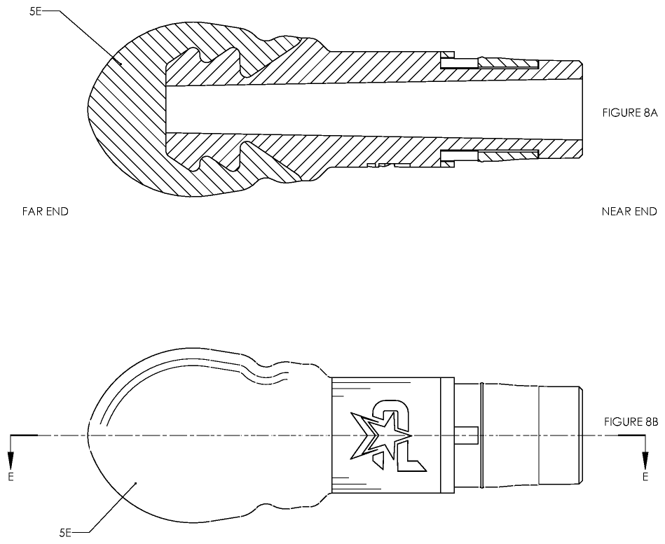

Referring to FIGS. 7a and 7b, the tip 5C of durometer value 60 as shown will deform 5 mm with an impact force of 31.12 Joules. By way of comparison, to deform tip 5C 7 mm, the force required is 62.5 Joules. Similar to the first low impact tool configuration of the first embodiment discussed above, this tool of FIGS. 7a and 7b is static, in that there are no adjustable features. Note that in comparing the tip configuration between tip 5B and 5C, merely changing the size and shape of the internal air chamber within the tip results in nearly doubling the required force to compress the tip 5 mm. But one skilled in the art will recognize that the variations introduced above with respect internal geometries of the second and third low impact tool configurations may also be applied hereto, by simply replacing tip 5A with tip 5C, thus providing a user with additional levels of impact to customize their massage experience.

### D. High Level Impact

In a fourth embodiment, an exemplary tool head for use with a percussion massager is intended to provide a user with a high impact level experience, or levels, as compared to other tool head configurations in a set of tool heads. Impact level can vary based on a number of factors including tool configuration, tip shape and material, as well as user selectable changes to the tool configuration as will be discussed herein. Use of the terms low, medium and high herein are relative.

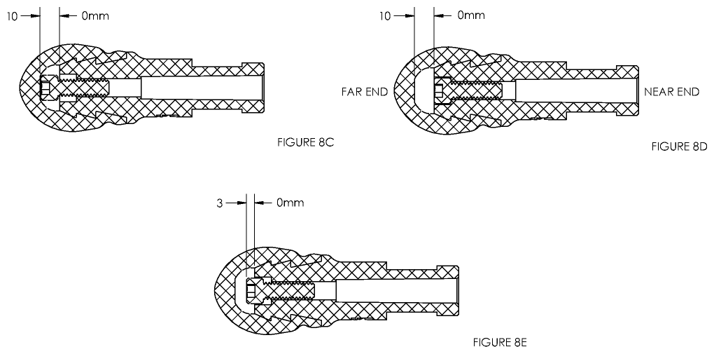

Referring to FIGS. 8a and 8b, the tip 5D of durometer value 60 as shown will deform 5 mm with an impact force of 127.26 Joules. By way of comparison, to deform tip 5D 7 mm, the force required is 224.99 Joules. Similar to the first low impact tool configuration of the first embodiment discussed above, this tool of FIGS. 8a and 8b is static, in that there are no adjustable features. But one skilled in the art will recognize that the variations introduced above with respect internal geometries of the second and third low impact tool configurations may also be applied hereto, by simply replacing tip 5A with tip 5D, thus providing a user with additional levels of impact to customize their massage experience. FIGS. 8c, 8d and 8e illustrate adjustable variations to the tool of FIGS. 8a and 8b, wherein impact can be adjusted by changing the width of an air gap 10 in the tip. In comparing these three configurations to one another, FIG. 8c with gap at 7 mm would be lowest impact, FIG. 8d with gap at 3 mm would be higher impact than FIG. 8c and FIG. 8e with essentially 0 mm gap would have highest impact.

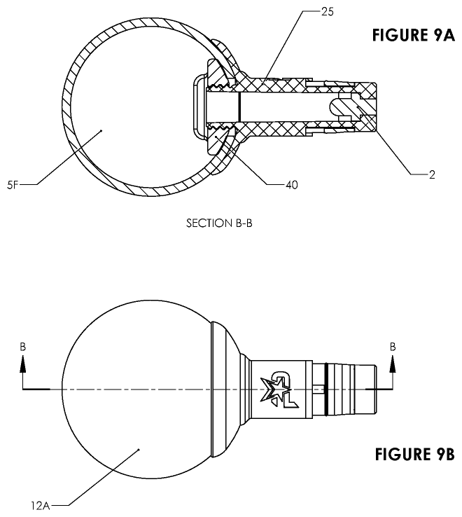

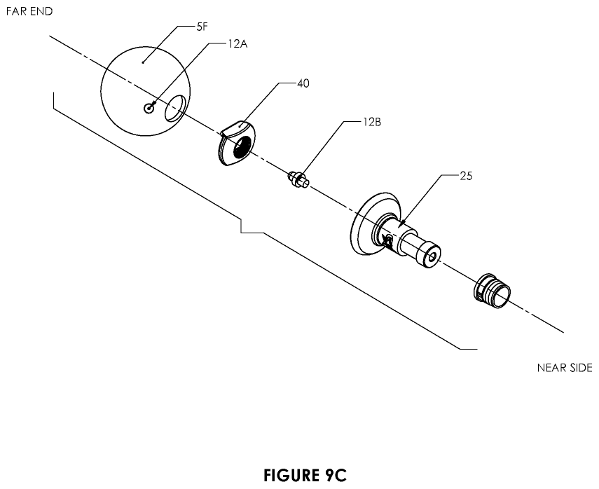

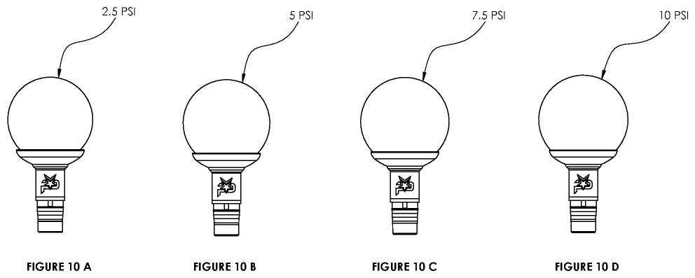

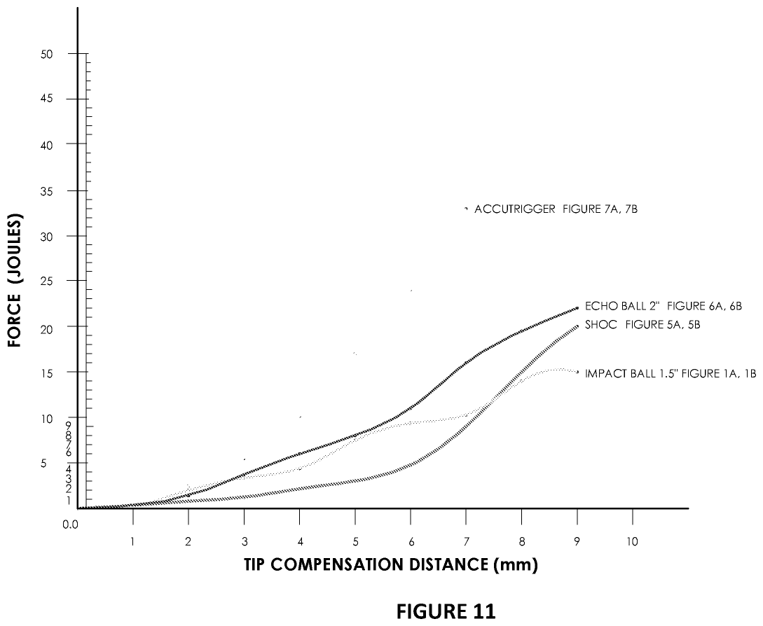

FIGS. 9a, 9b, and 9c illustrate yet another tool configuration which includes primary components of a shaft 25, nut 40, an inflatable/deflatable tip 5E and valves 12A and 12B. The inflatable/deflatable tip 5E can be inflated/deflated to achieve a predetermined PSI, which correlates with varying levels of impact force when used with a percussion massager. A user controls inflation and deflation of tip 5E through valves, 12A and 12B. The valves may be needle valves or other appropriate valves as would be recognized by one skilled in the art. In FIGS. 10a, 10b, 10c and 10d, the same tool is shown at different levels of inflation (PSI). One skilled in the art will appreciate that other tip configurations may be provided with the ability to inflate and deflate to adjust impact force during massaging. For example, one or more exemplary tips, including the roller tips described in commonly owned U.S. patent application Ser. No. 17/508,954 which is incorporated herein by reference in its entirety may include an inner tube or bladder which may be inflated.

FIG. 11 is an exemplary graph illustrating impact force (Joules) required to achieve tool tip compression (mm) for different tip designs during use with a percussion massage device. In this graph, the only difference between the tested tools is the design of the tip. That is, the tool configuration itself is static and identical and the durometer of each tip is the same. The tip design alone produces the differences in required force illustrated in FIG. 11.

With respect to all embodiments described above, changing the rubber durometer or the attachment tip shape, e.g., dome, cone, spade shaped, paddle shaped, spherical, circular, etc., could expand the impact range that is available to a user. Further, multiple adjustment mechanisms may be included in a single tool configuration, i.e., a single configuration could include an inflatable tip as well as the spring mechanism discussed above with respect to the third low impact tool configuration described with respect to FIGS. 3a, 3b and 3c.

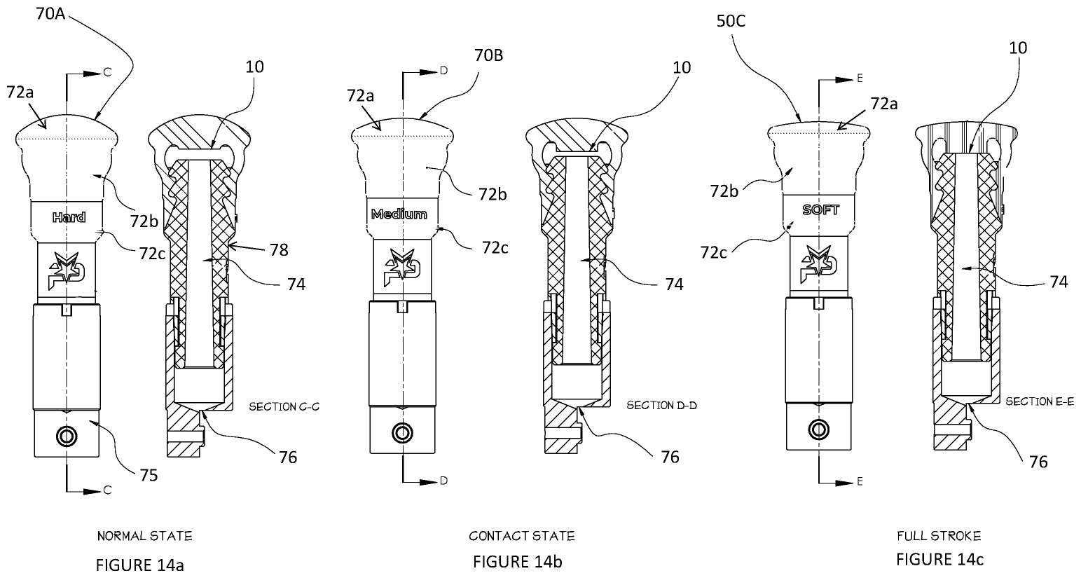

FIGS. 14a, 14b and 14c illustrate exemplary interchangeable tips 70A, 70B and 70C which are each of formed multiple sections 72a, 72b and 72c. The sections 72a, 72b and 72c are formed into a single tip having unitary construction. Each section may be formed of a different material or from the same material having different durometer values, thereby creating different resonance sections within the same part. Generally, shore durometers for the section materials are between 20-80 and, when varied between sections, vary by at least 10 durometer. These different tips are also shown in varying stroke positions, in order to exemplify the various degrees of freedom which are afforded to a user by having the ability to easily interchange tips with varying levels of hardness. In FIGS. 14a, 14b and 14c, the tips may be snapped on, so as to be interchangeable, to the hollow shaft 78. Air from the air gap 10 may be released during the stroke through one or more channels in the core 74 and out of the tool via one or more vents 76 in the piston 75.

For example, in FIG. 14a, tip 70A is comprised of materials having durometer values of 80 for 72a and 30 for each of 72b and 72c. These materials may have different colors and transparencies. For example, the 72a material can be translucent or transparent, 72b material can be black and the 72c material can be red, wherein red is associated with a tip having highest hardness.

In FIG. 14b, tip 70B is comprised of materials having durometer values of 50 for 72a and 30 for each of 72b and 72c. These materials may have different colors and transparencies. For example, the 72a material can be translucent or transparent, 72b material can be black and the 72c material can be orange, wherein orange is associated with a tip have medium hardness. In FIG. 14b, the user would be experiencing a medium impact with a medium softness tip.

Finally, FIG. 14c, tip 70C is comprised of materials having durometer values of 30 for each of 72a, 72b and 72c. These materials may have different colors and transparencies. For example, the material of 72a can be translucent or transparent, the material of 72b can be black and the material of 72c can be yellow, wherein yellow is associated with the softest tip available to the user.

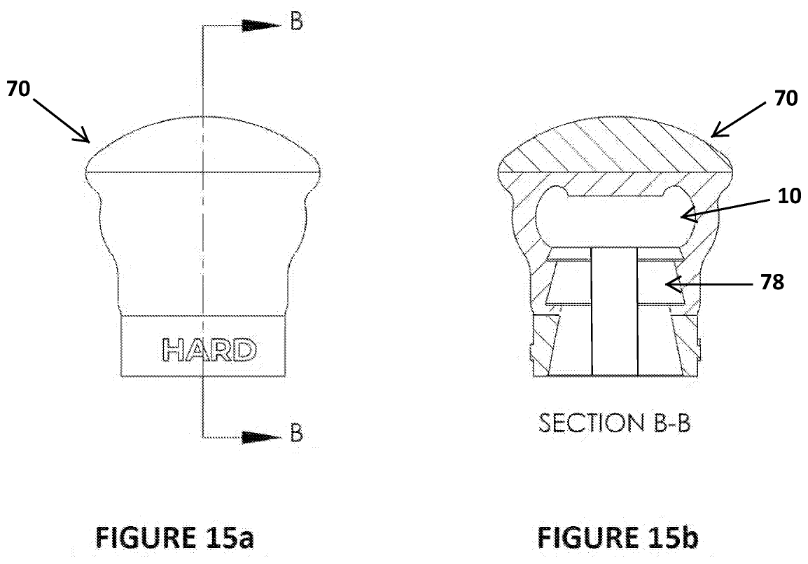

FIGS. 15a and 15b illustrate an exemplary tip configuration 70 and cross-sectional view showing how the tips may be permanently or snap-fit to the shaft 78.

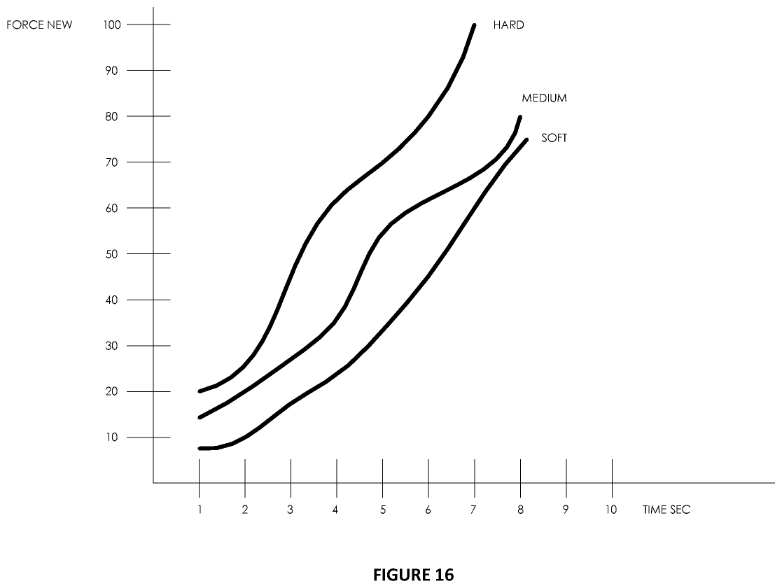

FIG. 16 provides an exemplary graph plotting Force v. Time for an exemplary tool tip having a same configuration, but with different hardness levels.

One skilled in the art will appreciate that these are merely exemplary values and that changes in durometer values across the three sections of the interchangeable tips can be used to increase or decrease impact. Materials may be selected from, e.g., rubber, silica, gel, or the like. For 72a, which directly impacts the user, a material should be selected to help avoid traumatic tissue damage. The ability to control durometer value of section 72b material provides even more control over absorption and reverberation, which will also effect impact. The material of 72c should be selected to facilitate interchangeability; fit on shaft ridge and to maintain stability.

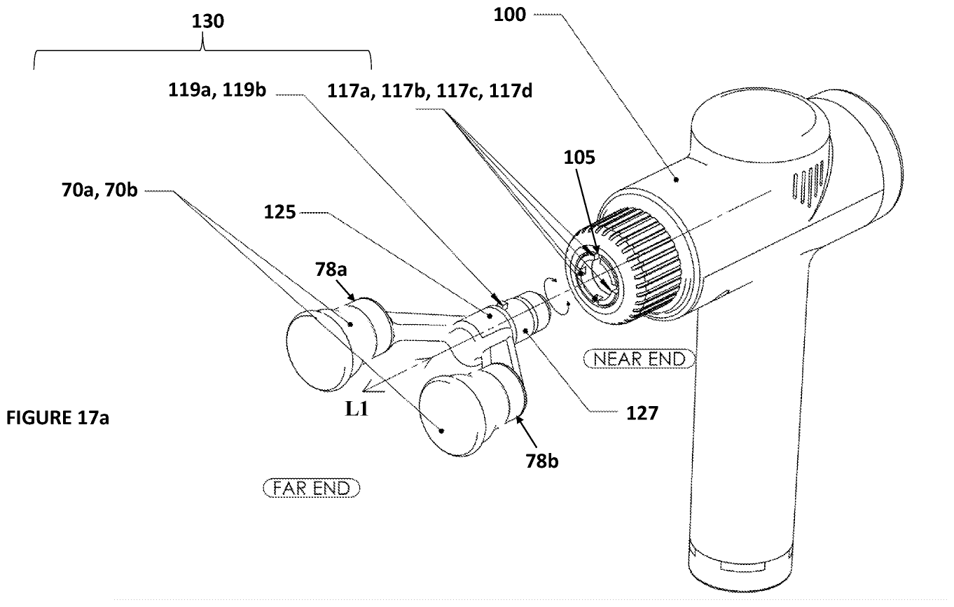

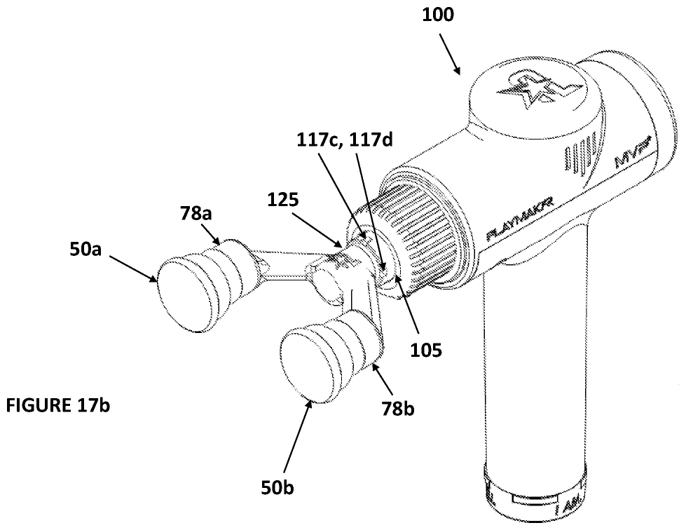

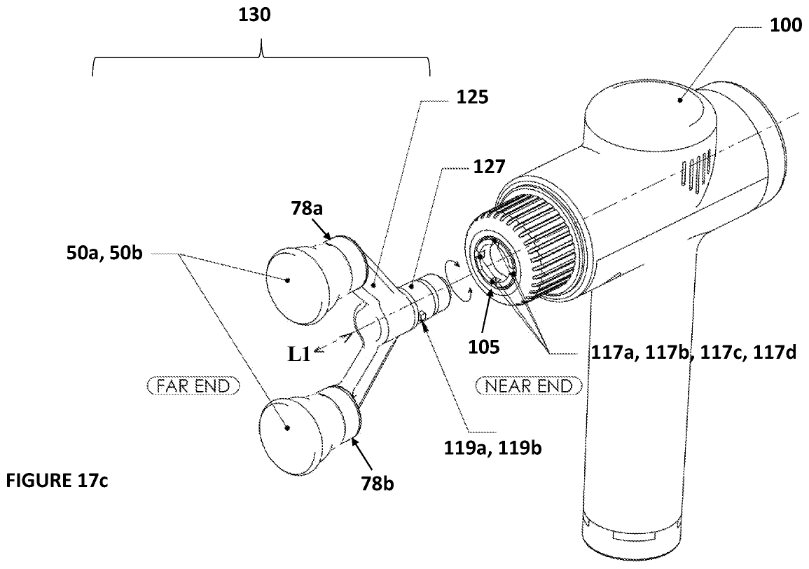

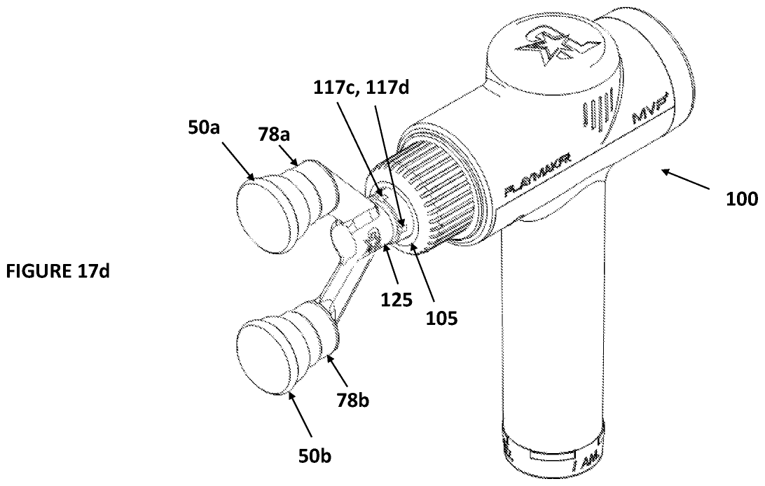

FIGS. 17a, 17b, 17c and 17d illustrate a percussive massaging device 100 that has a removable and rotatable tool 130. The tool 130 is rotatably fixed at a far end (e.g., distal end) of an attachment post 125 and has multiple tips 50a and 50b selectable from the tips described herein in accordance with desired hardness for providing a therapeutic effect along a longitudinal axis L1 of the attachment post 125 at two different points on the user's skin at the same time. Tips 50a and 50b can be permanently affixed to shafts 78a and 78b or snap-fit thereon so as to be interchangeable.

As described in U.S. patent application Ser. No. 17/508,954, which is incorporate herein by reference, the tool's attachment post 125 connects with a tool receiver 105 of the device 100 using a key and keyway configuration, wherein the tool receiver 105 includes multiple keyways, e.g., 117a, 117b, 117c, 117d which engaged with keys 119a and 119b on the tool's attachment post 125. In the preferred embodiment, there are four keyways, located at approximately positions 3, 6, 9 and 12 o-clock around the circumference of the approximately circular tool receiver. The attachment post keys engage with two keyways at a time to constrain the attachment post within the tool receiver. The attachment post 125 further includes a press-fit seal, e.g., elastomeric joint or Polyhedral seal 127, for ensuring secure engagement of the attachment post 125 with the tool receiver 105.

In FIG. 17b, the tool 130 is arranged in a first position when the two keys 119a and 119b engage with two keyways located opposite to one another within the entrance of the tool receiver 105. In FIG. 17d, the tool 130 is arranged in a second position when the two key 119a and 119b engage with the other two keyways located opposite to one another within the entrance of the tool receiver 105.

For those embodiments wherein multiple, exchangeable tips and/or tools are provided with the massager or otherwise available to the user (e.g., for individual purchase), the individual tips and/or tools may be marked by color, alphanumeric or other pictorial indicator which may be used to differentiate the anticipated level of impact force that a user might expect to receive from a particular tip and/or tool combination. For example, the color green may indicate low impact, the color yellow may indicate medium impact, the color orange may indicate medium/high impact and the color red may indicate high impact.

The tools, tips and attachment systems for a percussive massager device described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect. Also, it is to be understood that the phraseology and terminology employed herein are for the purpose of the description and should not be regarded as limiting.

We claim:

1. A massage head tip for use with a massage tool for a percussive massaging device, the tip comprising:
at least two sections, wherein a first of the at least two sections is formed of a first material having a first durometer value and a second of the at least two sections is formed of a second material having a second durometer value; and
further wherein the first durometer value is equal to or greater than the second durometer value.

2. The massage head tip of claim 1, further comprising a third section formed of a third material having a third durometer value, wherein the third durometer value is equal to or less than the first durometer value.

3. The massage head tip of claim 1, where the first durometer value is greater than the second durometer value in increments of 10.

4. The massage head tip of claim 1, wherein each of the first, second and third durometer values are in a range of 20 to 80 durometer value.

5. The massage head tip of claim 1, wherein the first material is translucent.

6. The massage head tip of claim 4, wherein the first material is selected from a group consisting of a rubber, a silica, or a gel.

7. A percussive massaging device comprising:
a removable hollow shaft connected on a first end to a tool receiver, including a piston, and at a second end to a massage tool;
wherein the massage tool includes at least one tool head tip, the tool head tip having at least two sections, wherein a first of the at least two sections is formed of a first material having a first durometer value and a second of the at least two sections is formed of a second material having a second durometer value; and
further wherein the first durometer value is equal to or greater than the second durometer value.

8. The percussive massaging device of claim 7, wherein the at least one tool head tip further includes a third section formed of a third material having a third durometer value, wherein the third durometer value is equal to or less than the first durometer value.

9. The percussive massaging device of claim 7, wherein the first durometer value is greater than the second durometer value in increments of 10.

10. The percussive massaging device of claim 7, wherein each of the first, second and third durometer values are in a range of 20 to 80 durometer value.

11. The percussive massaging device of claim 7, wherein the first material is translucent.

12. The percussive massaging device of claim 11, wherein the first material is selected from a group consisting of a rubber, a silica, or a gel.

13. The percussive massaging device of claim 7, wherein the least one tool head tip is removably snap-fit to the removable hollow shaft.

14. The percussive massaging device of claim 7, wherein the tool receiver includes one or more keyways and the removable hollow shaft includes multiple keys for engaging with the one or more keyways to secure the massage tool to the tool receiver.

15. The percussive massaging device of claim 14, wherein the tool receiver is approximately circular in shape and four keyways are located at approximately 3, 6, 9 and 12 o-clock around a perimeter of the tool receiver.

16. The percussive massaging device of claim 14, wherein the removable hollow shaft is approximately circular in shape and two keys are located on diametrically opposite sides of a perimeter of the removable hollow shaft.

17. The percussive massaging device of claim 14, wherein the tool head is aligned in one of a vertical and horizontal alignment in accordance with alignment of the two keys with a first and second pair of keyways.

18. A massage tool for a percussive massaging device, the massage tool comprising:
a tool head having an attachment post at a first end thereof for attaching to a tool receiver and dual fork ends at a second end thereof, wherein each of the dual fork ends includes a tool head tip attached thereto;
each tool head tip having at least two sections, wherein a first of the at least two sections is formed of a first material having a first durometer value and a second of the at least two sections is formed of a second material having a second durometer value; and
further wherein the first durometer value is equal to or greater than the second durometer value.

19. The massage tool of claim 18, wherein each tool head tip further includes a third section formed of a third material having a third durometer value, wherein the third durometer value is equal to or less than the first durometer value.

20. The massage tool of claim 18, wherein the first durometer value is greater than the second durometer value in increments of 10.

21. The massage tool of claim 19, wherein each of the first, second and third durometer values are in a range of 20 to 80 durometer value.

22. The massage tool of claim 18, wherein the first material is translucent.

23. The massage tool of claim 22, wherein the first material is selected from a group consisting of a rubber, a silica, or a gel.

24. The massage tool of claim 18, wherein each head tip is removably snap-fit to a fork end.

25. The massage tool of claim 18, wherein the tool receiver includes one or more keyways and the attachment post includes multiple keys for engaging with the one or more keyways to secure the massage tool to the tool receiver.

26. The massage tool of claim 25, wherein the tool receiver is approximately circular in shape and four keyways are located at approximately 3, 6, 9 and 12 o-clock around a perimeter of the tool receiver.

27. The massage tool of claim 25, wherein the attachment post is approximately circular in shape and two keys are located on diametrically opposite sides of a perimeter of the attachment post.

28. The massage tool of claim 25, wherein the tool head is aligned in one of a vertical and horizontal alignment in accordance with alignment of two keys with a first and second pair of keyways.
